(19) United States
(12) Patent Application Publication
(10) Pub. No.: US 2014/0373102 A1
(43) Pub. Date: Dec. 18, 2014

(54) SERVER DEVICE, CONTENT DISTRIBUTION CONTROL DEVICE, AND CONTENT DISTRIBUTION SYSTEM

(71) Applicant: FUNAI ELECTRIC CO., LTD., Osaka (JP)

(72) Inventor: Munehiko FUJIMOTO, Osaka (JP)

(73) Assignee: FUNAI ELECTRIC CO., LTD., Osaka (JP)

(21) Appl. No.: 14/284,802

(22) Filed: May 22, 2014

(30) Foreign Application Priority Data
Jun. 18, 2013 (JP) 2013-127889

(51) Int. Cl. H04L 29/06

(52) U.S. Cl. CPC H04L 63/10
USPC 726/4

(57) ABSTRACT

A smartphone provides a content to a client device that displays the contents on a screen. The smartphone includes a gyro sensor and a control unit. The gyro sensor detects a direction that the smartphone is facing. The control unit stops transmission of a predetermined content for which confidentiality is to be preserved when the gyro sensor detects that the smartphone is facing a predetermined direction.

### CROSS REFERENCE TO RELATED APPLICATION

The present application is based on and claims priority of Japanese Patent Application No. 2013-127889 filed on Jun. 18, 2013. The entire disclosure of the above-identified application, including the specification, drawings and claims is incorporated herein by reference in its entirety.

### FIELD

The present invention relates to server devices, content distribution control devices, and content distribution systems, and more particularly to control of distribution of a content for which confidentiality is to be preserved.

### BACKGROUND

Viewing contents in a home network has been popular (for example, see Patent Literature 1). Home network communication techniques represented by Digital Living Network Alliance® (DLNA) are essentially for “publishing” contents, not “keeping private (not publishing)” contents. Even DLNA® does not have a function of switching each content between publishable and private, but is designed to publish any kinds of contents stored in a Digital Media Server (DMS). Although there is a Digital Rights Management (DRM) technique of managing whether or not to display contents, the DRM technique is not considered to prevent even distribution of the contents.

For example, a home network technique, such as DLNA®, allows family members to freely view photographs captured by a smartphone or the like, so that not only an individual but as also all the family members can easily share the photographs. However, smartphones, tablet terminals, general digital still cameras, and the like, which are capable of storing photographs, do not have a capability of managing the stored photographs in consideration of individual privacy. All the photographs captured by the same smartphone or the like are therefore published in the home network, not being distinguished between “photographs publishable” or “photographs in private”.

While the home network is used only by an individual, there is no problem of publishing any of the “photographs publishable” and the “photographs in private”. However, if a content player used by a different person is connected to the home network, there is a risk that the different person views the “photographs in private”. It is therefore necessary to instantaneously stop publishing the “photographs in private” without bothering setting operations.

There is also the situation where a user wishes to hide, in haste, photographs of peculiar interests (namely, “photographs in private”) displayed on a television screen in a room when an intimate person (for example, a family member) suddenly enters the room.

The similar problems occur also in network systems having wireless display functions represented by Miracast® besides DLNA®. In the case of smartphones, for example, the wireless display function is used to mirror, on a television screen, any video currently displayed on a display unit of a smartphone. However, a smartphone is a representative of devices storing a large amount of highly-confidential private information, and there are many use cases for enjoying Video On Demand (VOD), photograph slide show, and the like by the Miracast® function. In the use cases, there are the same problems as occurred in DLNA®. In other words, there is a demand for stopping, in haste, displaying of a highly-confidential content when someone suddenly appears in an environment where the content is visible.

### CITATION LIST

### Patent Literature

[Patent Literature 1] Japanese Unexamined Patent Application Publication No. 2009-223048

### SUMMARY

### Technical Problem

However, when a content is viewed in such a conventional home network, it is difficult to instantaneously stop displaying of a highly-confidential content.

In order to solve the conventional problems, an object of the present invention is to provide a server device or the like which is capable of instantaneously stopping displaying a highly-confidential content.

### Solution to Problem

In accordance with an aspect of the present invention for achieving the object, there is provided a server device that transmits a content to a client device that displays the content on a screen, the server device including: a direction detection unit configured to detect a direction that the server device is facing; and a control unit configured to stop transmission of a confidential content when the direction detection unit detects that the server device is facing a predetermined direction, the confidential content being a predetermined content for which confidentiality is to be preserved.

With the above structure, it is possible to stop transmitting a confidential content from the server device, by causing the server device to face a predetermined direction. As a result, it is possible to instantaneously stop displaying a highly-confidential content on the client device.

For example, it is possible that the control unit is further configured to transmit a list to the client device when the direction detection unit detects that the server device is facing the predetermined direction, the list indicating a storage place of each of contents except the confidential content, and the client device obtains the each of the contents from the storage place indicated in the list received from the control unit, and displays the each of the contents on the screen.

With the above structure, it is possible to remove information of a storage place of a confidential content from the content list, by causing the server device to face the predetermined direction. The client device therefore becomes unable to access the confidential content. As a result, it is possible to instantaneously stop displaying of the highly-confidential content on the client device.

It is also possible that the control unit is configured to stop the transmission of the confidential content when the direction detection unit detects that a display screen of the server device is facing downward.

With the above structure, it is possible to stop transmission of a confidential content, by user's action of hiding the display screen of the server device. The hiding of the display screen is a human intuitive action for conceal something from view. As a result, a usability of the server device can be improved.

It is further possible that the control unit is further configured to maintain the stopping of the transmission of the confidential content when the direction detection unit detects that the server device is facing a direction different from the predetermined direction after facing the predetermined direction.

With the above structure, it is possible to prevent that the transmission of the confidential content is restarted after stopping the transmission. As a result, the confidential content can be hidden from others.

It is still further possible that the server device is a digital media server in 2-Box model of Digital Living Network Alliance® (DLNA)-compliant protocols to transmit the content to the client device, and the client device is a digital media player in the 2-Box model of the DLNA®-compliant protocols.

With the structure, the server device can instantaneously stop displaying of a highly-confidential content, even if the server device is a digital media server in 2-Box model of DLNA®-compliant protocols (hereinafter, referred to also as “DLNA® 2-Box model”).

It is still further possible that the server device transmits a content currently displayed on the server device, to the client device according to Miracast®, and the control unit is configured to, when the direction detection unit detects that the server device is facing the predetermined direction, stop the transmission of the confidential content by stopping displaying of the confidential content on the server device.

With the structure, the server device can instantaneously stop displaying of a highly-confidential content, even if the server device is a source device using Miracast®.

In accordance with another aspect of the present invention, there is provided a content distribution control device that controls transmission of a content from a server device to a client device that displays the content on a screen, the content distribution control device including: a direction detection unit configured to detect a direction that the content distribution control device is facing; and a control unit configured to stop transmission of a confidential content from the server device to the client device, when the direction detection unit detects that the content distribution control device is facing a predetermined direction, the confidential content being a predetermined content for which confidentiality is to be preserved.

With the above structure, it is possible to stop transmitting a confidential content from the server device, by causing the content distribution control device to face a predetermined direction. As a result, it is possible to instantaneously stop displaying the highly-confidential content. For example, it is possible to instantaneously stop displaying of a highly-confidential content, even if the content distribution control device is a digital media controller in 3-Box model of DLNA®-compliant protocols (hereinafter, referred to also as “DLNA® 3-Box model”).

In accordance with still another aspect of the present invention, there is provided a content distribution system including: a server device that transmits a content; and a client device that receives the content transmitted from the server device and displays the content on a screen, wherein the server device includes: a direction detection unit configured to direct a direction that the server device is facing; and a control unit configured to stop transmission of a confidential content when the direction detection unit detects that the server device is facing a predetermined direction, the confidential content being a predetermined content for which confidentiality is to be preserved.

With the above structure, it is possible to stop transmitting a confidential content from the server device, by causing the server device to face a predetermined direction. As a result, it is possible to instantaneously stop displaying the highly-confidential content.

For example, it is possible that the client device displays, on the screen, a predetermined image not including the confidential content, when the server device stops the transmission of the confidential content.

With the above structure, it is possible to conceal, from others, the fact of having viewed a confidential content.

More specifically, it is also possible that the predetermined image is a predetermined menu image.

With the above structure, a user can pretend, in front of others, to have viewed a menu image not a confidential content.

Furthermore, it is possible that the predetermined image is an image of a list of one or more contents except the confidential content.

With the above structure, the user can pretend, in front of others, that the server device has never stored a confidential content.

It should be noted that the present invention may be implemented not only to the server device including the above-described characteristic processing units, but also to a content distribution method including steps performed by the characteristic processing units of the server device. The present invention may be implemented also to: a program causing a computer to execute the characteristic steps performed by the processing units of the server device; and a program causing a computer to execute the characteristic steps included in the content distribution method. Of course, the program can be distributed via a non-transitory computer-readable recording medium such as a Compact Disc-Read Only Memory (CD-ROM) or via a communication network such as the Internet.

### Advantageous Effects

The present embodiment can provide a server device or the like which is capable of instantaneously stopping displaying of a highly-confidential content.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a diagram illustrating a configuration of a content distribution system according to Embodiment 1.

FIG. 2 is a block diagram illustrating a functional structure of a smartphone according to Embodiment 1.

FIG. 3 is an example of pieces of profile information according to Embodiment 1.

FIG. 4 is a block diagram illustrating a functional structure of a television set according to Embodiment 1.

FIG. 5 is a flowchart of processing performed by the smartphone according to Embodiment 1.

FIG. 6 is an example of a content list according to Embodiment 1.

FIG. 7 illustrates the state where the smartphone is placed on a floor according to Embodiment 1.

FIG. 8 illustrates an example of a content list not including information of a confidential content according to Embodiment 1.

FIG. 9 is a flowchart of processing performed by the television set according to the processing performed by the smartphone in FIG. 5 according to Embodiment 1.

FIG. 10 is a flowchart of generating a piece of profile information according to Embodiment 1.

FIG. 11 is a diagram illustrating an example of a television display screen in the case where profile information is generated, according to Embodiment 1.

FIG. 12 is a diagram illustrating another example of a television display screen in the case where profile information is generated, according to Embodiment 1.

FIG. 13 is a diagram illustrating still another example of a television display screen in the case where profile information is generated, according to Embodiment 1.

FIG. 14 is a block diagram illustrating a functional structure of a smartphone according to Embodiment 2.

FIG. 15 is a block diagram illustrating a functional structure of a television set according to Embodiment 2.

FIG. 16 is a flowchart of processing performed by the smartphone according to Embodiment 2.

FIG. 17 is a flowchart of processing that is performed by the television set according to the processing performed by the smartphone in FIG. 16 according to Embodiment 2.

FIG. 18 is a diagram illustrating an example of a configuration of a content distribution system in DLNA® 3-Box model according to another Embodiment.

### DESCRIPTION OF EMBODIMENT(S)

Hereinafter, certain exemplary embodiments are described in greater detail with reference to the accompanying Drawings. It should be noted that all the embodiments described below are specific examples of the present invention. Numerical values, shapes, materials, constituent elements, arrangement positions and the connection configuration of the constituent elements, steps, the order of the steps, and the like described in the following embodiments are merely examples, and are not intended to limit the present invention. Therefore, among the constituent elements in the following embodiments, constituent elements that are not described in independent claims are described as arbitrary constituent elements.

### Embodiment 1

The following describes a content distribution system according to Embodiment 1. The content distribution system according to Embodiment 1 adopts connection according to DLNA®-compliant protocols.

### 1. Configuration

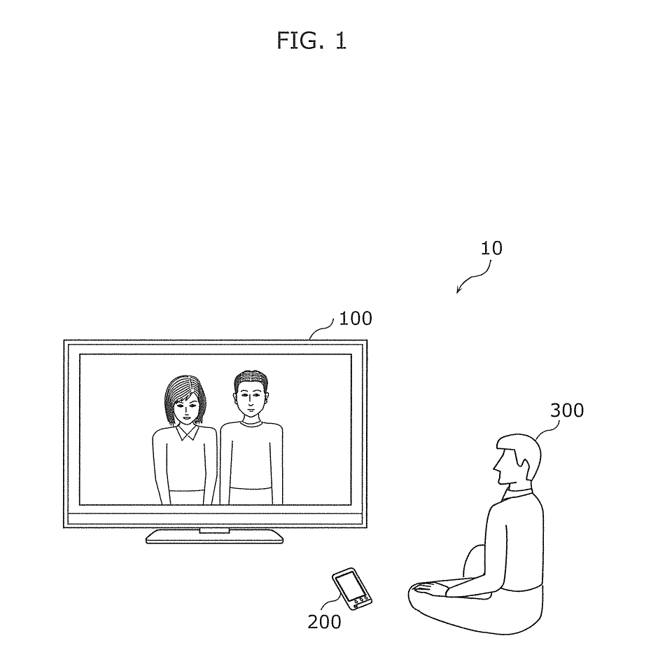

FIG. 1 is a diagram illustrating a configuration of the content distribution system according to Embodiment 1.

A content distribution system 10 includes: a television set 100 that displays a content; and a smartphone 200 that serves as a server device for distributing the content. A user 300 operates the smartphone 200 to display the content stored in the smartphone 200, on a display screen of the television set 100. In the present embodiment, the television set 100 and the smartphone 200 serve as a Digital Media Player (DMP) and a Digital Media Server (DMS), respectively, in 2-Box model using DLNA®-compliant protocols. In other words, the smartphone 200 distributes via a network the content stored in the smartphone 200, and the television set 100 receives the distributed content and displays the received content on the display screen. The user 300 can view the content on the display screen of the television set 100.

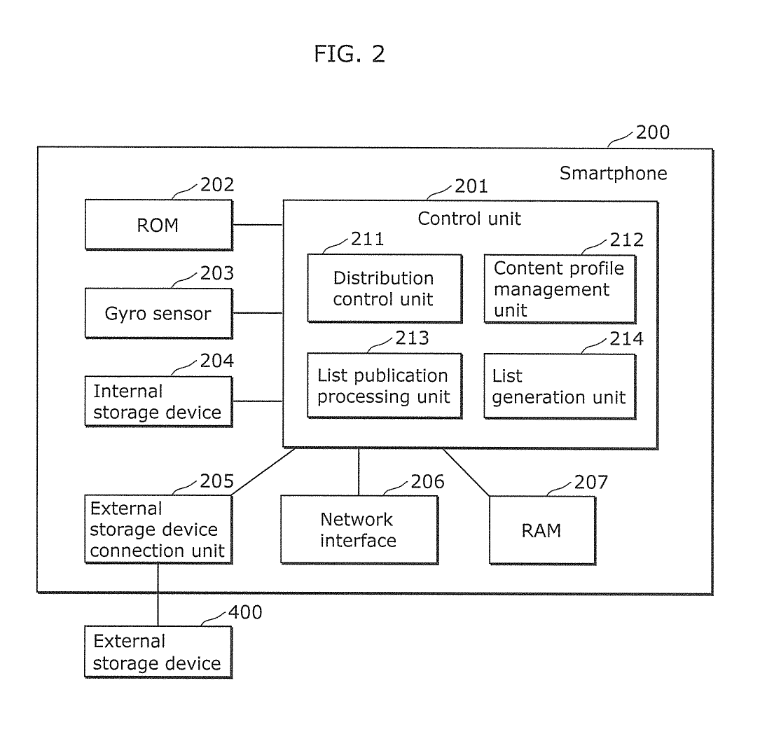

FIG. 2 is a block diagram illustrating a functional structure of the smartphone 200.

The smartphone 200 includes a control unit 201, a Read Only Memory (ROM) 202, a gyro sensor 203, an internal storage device 204, an external storage device connection unit 205, a network interface 206, and a Random Access Memory (RAM) 207.

The control unit 201 controls each of the processing units in the smartphone 200. An example of the control unit 201 is a Central Processing Unit (CPU).

The ROM 202 stores a program and the like for activating the smartphone 200.

The gyro sensor 203 is an example of the direction detection unit according to the aspect of the present invention. The gyro sensor 203 detects a direction that the smartphone 200 is facing.

The internal storage device 204 stores contents such as image data and video data. An example of the internal storage device 204 is a flash memory.

The external storage device connection unit 205 is an interface for connecting the smartphone 200 to an external storage device 400. An example of the external storage device 400 is a memory card. The external storage device 400 stores contents.

The network interface 206 is an interface for wireless communication with external devices. For example, the network interface 206 wirelessly communicates with the television set 100 via an access point.

The RAM 207 temporarily stores various pieces of data. The RAM 207 stores a content list described later in this description.

The control unit 201 includes a distribution control unit 211, a content profile management unit 212, a list publication processing unit 213, and a list generation unit 214. These processing units 211, 212, 213, and 214 function when a program is executed.

The distribution control unit 211 controls contribution of contents. More specifically, when it is determined based on an output of the gyro sensor 203 that the smartphone 200 is facing a predetermined direction, the distribution control unit 211 stops distributing a predetermined content for which confidentiality is to be preserved (hereinafter, referred to also as a “confidential content”).

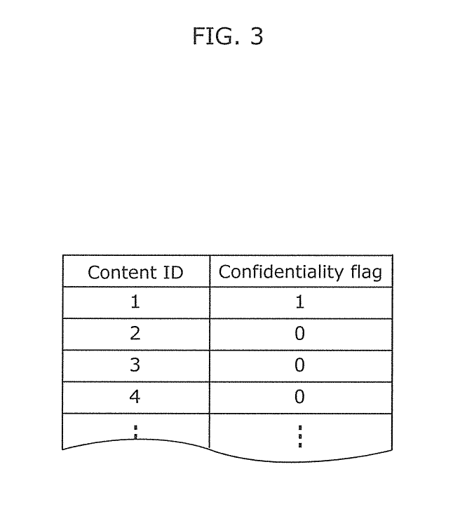

The content profile management unit 212 generates profile information that indicates whether or not each of contents stored in the internal storage device 204 or the external storage device 400 is confidential. The content profile management unit 212 stores the generated profile information in the RAM 207 or the internal storage device 204. FIG. 3 illustrates an example of the profile information. The profile information includes, for each of the stored contents, a content ID for identifying the content, and a confidentiality flag indicating whether or not the content is confidential. If a value of the confidentiality flag is 1, it means that the content is confidential. On the other hand, if a value of the confidentiality flag is 0, it means that the content is not confidential.

The list generation unit 214 generates a content list that includes, for each of the stored content, a storage place and metadata of the content. The metadata of a content includes a title, a data size, a resolution, and the like of the content.

The list publication processing unit 213 provides the content list generated by the list generation unit 214, to the television set 100 via the network interface 206.

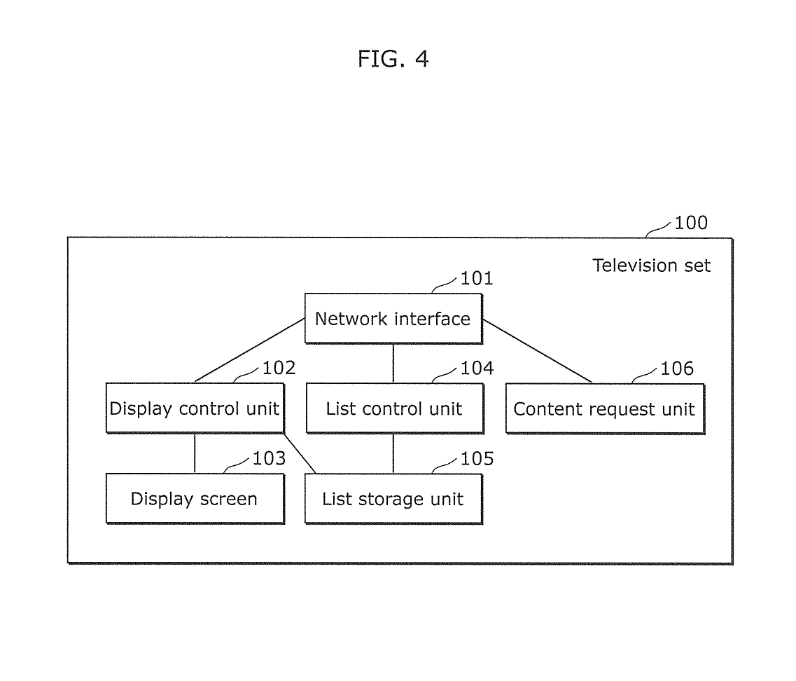

FIG. 4 is a block diagram illustrating a functional structure of the television set 100.

The television set 100 includes a network interface 101, a display control unit 102, a display screen 103, a list control unit 104, a list storage unit 105, and a content request unit 106.

The network interface 101 is an interface for wireless communication with external devices. For example, the network interface 101 wirelessly communicates with the smartphone 200 via an access point.

The display screen 103 is a screen on which image is displayed. An example of the display screen 103 is a liquid crystal panel.

The display control unit 102 controls displaying of a content and the content list on the display screen 103.

The list storage unit 105 stores the content list. An example of the list storage unit 105 is a RAM.

The list control unit 104 receives the content list from the smartphone 200 via the network interface 101, and stores the received content list into the list storage unit 105.

The content request unit 106 requests, via the network interface 101, the smartphone 200 to provide a content.

### 2. Processing

The following describes the processing performed by the content distribution system 10 with reference to a detail example.

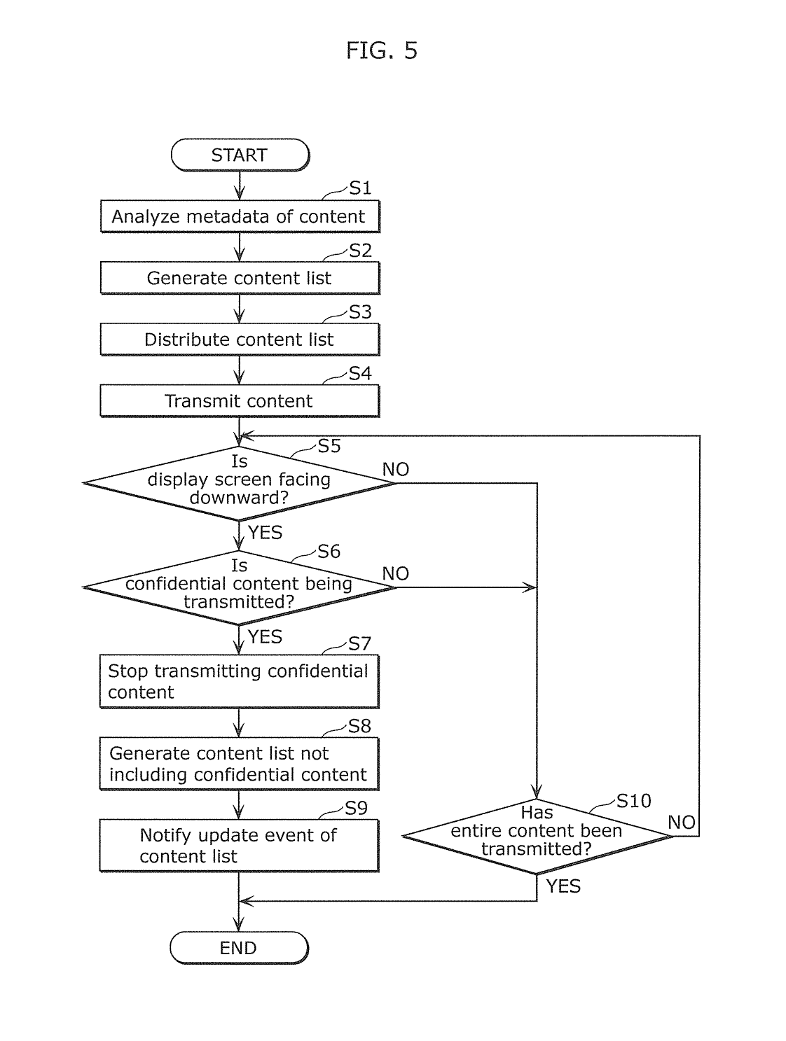

FIG. 5 is a flowchart of processing performed by the smartphone 200.

The list generation unit 214 analyzes metadata of each of the contents stored in the internal storage device 204 or the external storage device 400, by examining the stored contents (S1). In other words, for each of the contents, the list generation unit 214 obtains metadata of the content, such as a title, a data size, and a resolution, from header information of the content.

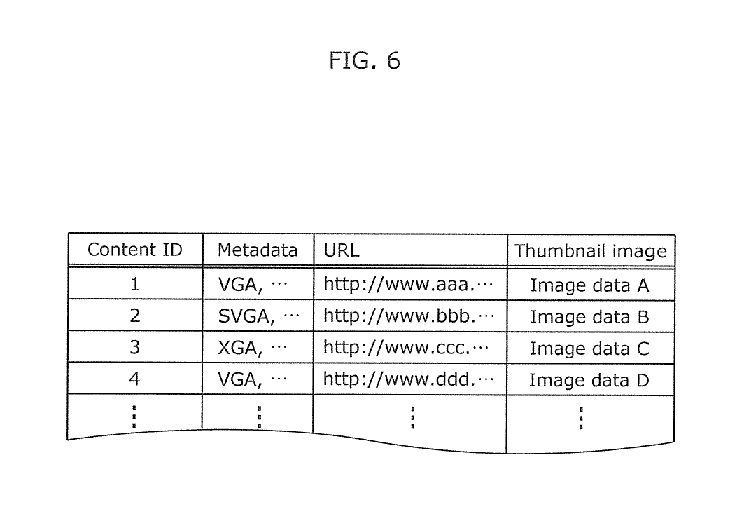

The list generation unit 214 generates a content list that includes the analyzed metadata and an Uniform Resource Locator (URL) indicating a storage place for each of the contents (S2). FIG. 6 illustrates an example of the content list. The content list includes a content ID, metadata, an URL, and a thumbnail image for each of the contents. The content ID is an identifier of the content. The thumbnail image is image data of size-reduced image representing the content. If the content is video data, for example, it is also possible to generate a thumbnail image by reducing a size of the first picture in the video data.

The list publication processing unit 213 provides the generated content list to the television set 100 via the network (S3).

when a request for providing a certain content is received from the television set 100, the distribution control unit 211 transmits the requested content to the television set 100 via the network (S4). The request for content providing includes an URL of the content. The distribution control unit 211 provides the television set 100 with a content stored in a storage place indicted by the URL.

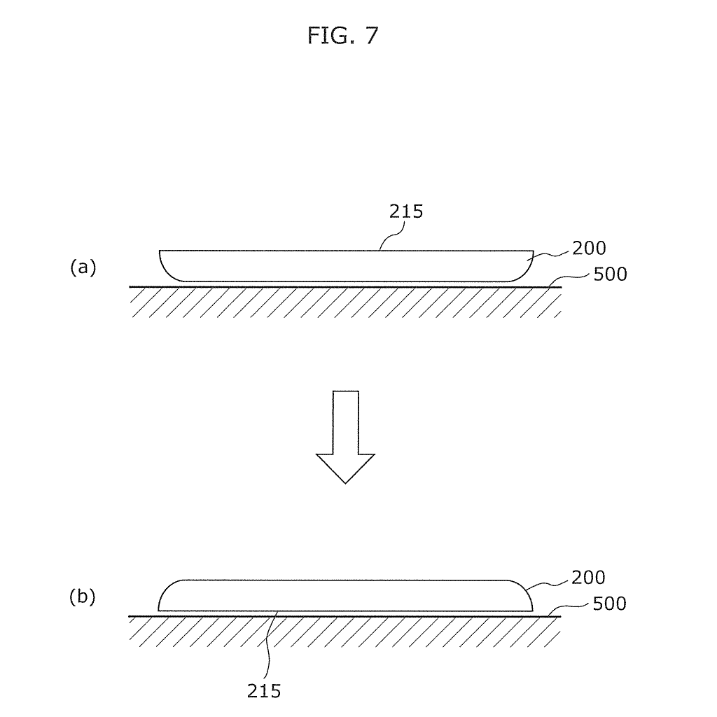

The distribution control unit 211 determines, based on an output of the gyro sensor 203, whether or not the display screen of the smartphone 200 is facing downward (S5). FIG. 7 illustrates the states where the smartphone 200 is placed on a floor 500. (a) in FIG. 7 illustrates the state where a display screen 215 of the smartphone 200 is facing upward. (b) in FIG. 7 illustrates the state where the display screen 215 of the smartphone 200 is facing downward.

If the display screen 215 of the smartphone 200 is facing downward as illustrated in (b) in FIG. 7 (YES at S5), the distribution control unit 211 determines, based on the profile information (FIG. 3), whether or not a currently-transmitting content is confidential (S6).

If the currently-transmitting content is confidential (YES at S6), then the distribution control unit 211 stops transmission of the current confidential content (S7). Here, the distribution control unit 211 may transmit, to the television set 100, a signal for stopping the transmission of the confidential content.

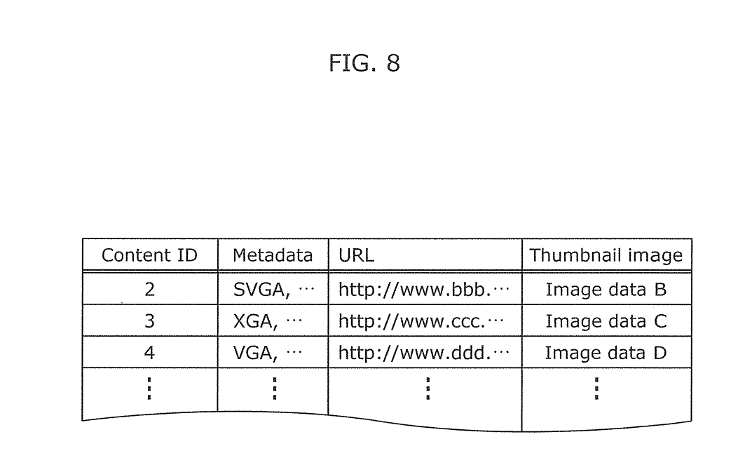

Furthermore, the list generation unit 214 generates a content list from which information of the confidential content is removed (S8). For example, the list generation unit 214 removes information of the confidential content (information of a content having a content ID of 1) from the content list illustrated in FIG. 6, thereby generating a new content list as illustrated in FIG. 8.

The list publication processing unit 213 notifies the television set 100 of an update event indicating that the content list has been updated (S9). Thereby, the list publication processing unit 213 causes the television set 100 to obtain the new content list, and prevents the television set 100 from obtaining the confidential content from the smartphone 200.

On the other hand, if the display screen of the smartphone 200 is facing any other direction except downward (NO at S5), or if the currently-transmitting content is not confidential (NO at S6), then the processing from S5 is repeated until the transmission of the current content have been completed.

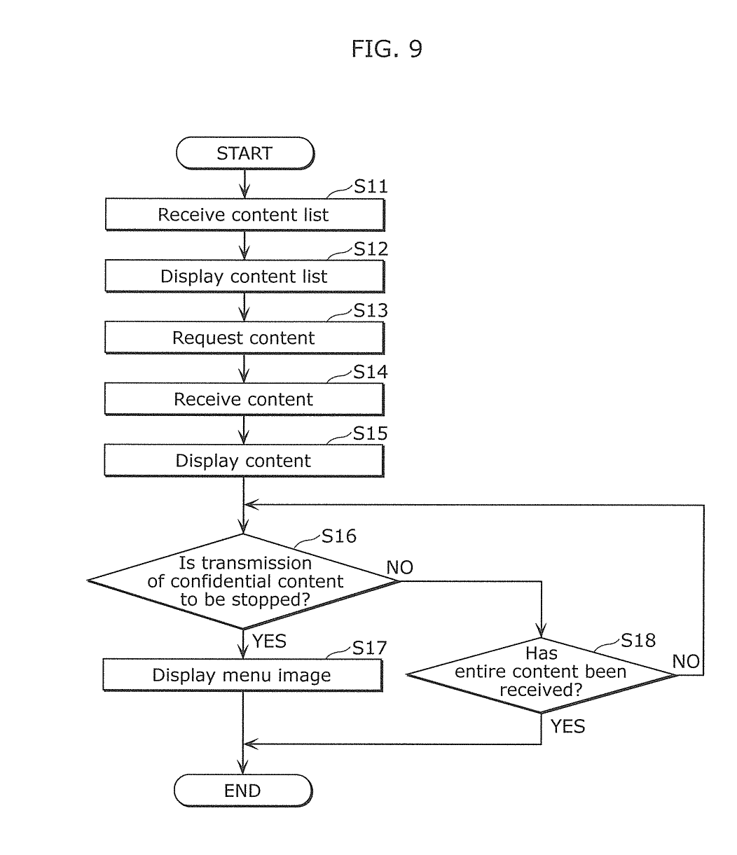

FIG. 9 is a flowchart of processing that is performed by the television set 100 according to the processing performed by the smartphone 200 in FIG. 5.

The list control unit 104 receives the content list from the smartphone 200, and stores the received content list into the list storage unit 105 (S11).

The display control unit 102 displays, on the display screen 103, the content list stored in the list storage unit 105 (S12).

If a user selects a content from the content list displayed on the display screen 103, then the content request unit 106 transmits, to the smartphone 200, a request for providing the selected content (S13). More specifically, the content request unit 106 obtains an URL of the content selected from the content list, and transmits the obtained URL together with the content request to the smartphone 200. Here, the selection of a content is performed, for example, by using a remote controller of the television set 100.

The display control unit 102 receives the content that is transmitted from the smartphone 200 in response to the content request (S14). The display control unit 102 displays the received content on the display screen 103 (S15).

If transmission of a confidential content is stopped during displaying of the confidential content (YES at S16), the display control unit 102 displays a menu image of the television set 100 instead of the confidential content (S17). It is also possible that the display control unit 102 determines that the transmission of the confidential content is stopped, if a signal for stopping the transmission of the confidential content is received.

On the other hand, if the transmission of the confidential content is not stopped (NO at S16), then the processing from S16 is repeated until the entire content has been received (S18).

### 3. Use Example

Next, an use example of the content distribution system 10 is described.

For example, as illustrated in FIG. 1, it is assumed that the user 300 is viewing a confidential content stored in the smartphone 200, on a display screen of the television set 100 in a user's room. This confidential content is a content which the user 300 does not wish to allow others to view.

Under the situation, when a family member enters the user's room, the user 300 wishes to stop, in haste, displaying the confidential content on the television set 100. Therefore, the user 300 changes the direction that the display screen 215 of the smartphone 200 is facing, from upward as illustrated in (a) in FIG. 7 to downward as illustrated in (b) in FIG. 7.

The changing stops the transmission of the confidential content from the smartphone 200 to the television set 100. Furthermore, on the screen of the television set 100, a menu image is displayed instead. As a result, the user can stop displaying of the confidential content, without causing the family member to notice that the confidential content has been displayed on the display screen of the television set 100.

Then, after that, even if the direction that the display screen 215 of the smartphone 200 is changed to upward as illustrated in (a) in FIG. 7, the smartphone 200 maintains stopping the transmission of the confidential content. As a result, it is possible to prevent that the transmission of the confidential content is restarted.

### 4. Generation of Profile Information

Next, the generation of the profile information illustrated in FIG. 3 is described.

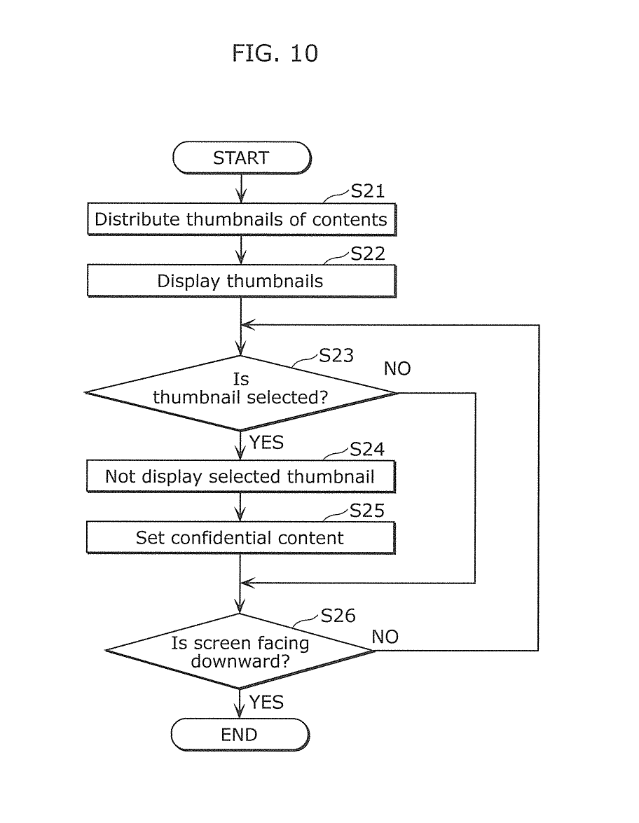

FIG. 10 is a flowchart of generating the profile information. The generation of the profile information is performed prior to distribution (transmission) of contents.

The distribution control unit 211 in the smartphone 200 provides the television set 100 with thumbnails of the contents stored in the internal storage device 204 or the external storage device 400 (S21).

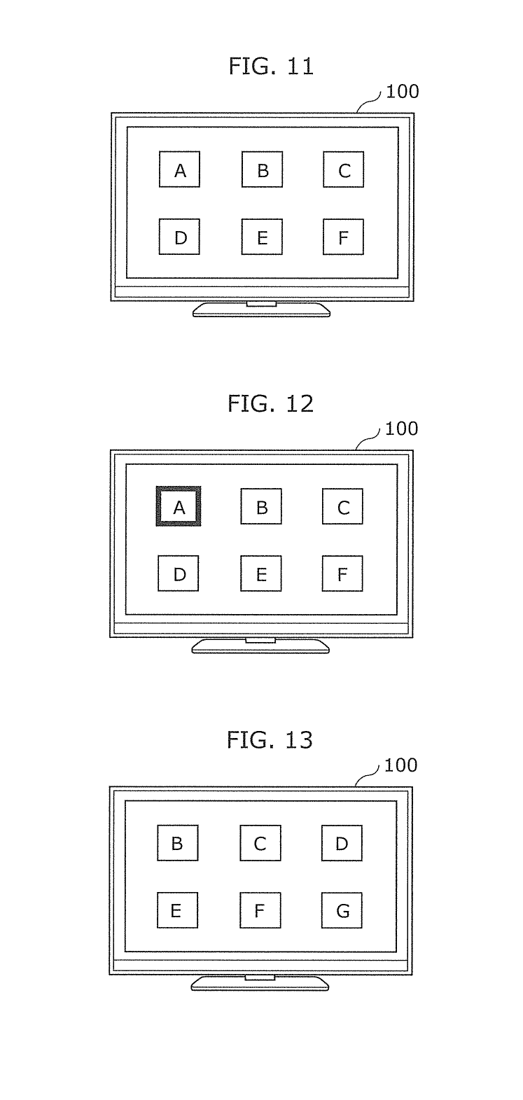

The display control unit 102 in the television set 100 receives the thumbnails from the smartphone 200, and displays the received thumbnails on the display screen 103 (S22). For example, as illustrated in FIG. 11, it is assumed that six thumbnails (thumbnails A to F) are displayed on the display screen of the television set 100. Here, the same thumbnails are assumed to be displayed also on the display screen 215 of the smartphone 200.

If the user selects one of the thumbnails by operating the smartphone 200 (YES at S23), then the distribution control unit 211 transmits information of the selected thumbnail to the television set 100. The display control unit 102 in the television set 100 causes the user's selected thumbnail not to be displayed according to the transmitted information (S24). For example, as illustrated in FIG. 12, it is assumed that the user touches the thumbnail A displayed on the display screen 215 of the smartphone 200, thereby selecting the thumbnail A. In this case, the selected thumbnail A is surrounded by a thick line. After that, the display control unit 102 does not display the selected thumbnail A as illustrated in FIG. 13.

Furthermore, the content profile management unit 212 in the smartphone 200 sets, in the profile information (FIG. 3), that a content corresponding to the user's selected thumbnail is confidential (S25). In other words, the content profile management unit 212 sets a confidentiality flag of the content to 1.

The control unit 201 determines, based on an output of the gyro sensor 203, whether or not the display screen 215 of the smartphone 200 is facing downward (S26). If the display screen 215 is facing downward (YES at S26), then it is determined that generation of the profile information has been completed, and therefore the processing is ended. On the other hand, if the display screen 215 does not face downward (NO at S26), then the processing from S23 is repeated.

### 5. Effects

As described above, in the content distribution system 10 according to Embodiment 1, it is possible to stop transmission of a confidential content from the smartphone 200 by causing the display screen of the smartphone 200 to face downward. Therefore, it is possible to instantaneously stop displaying of a highly-confidential content on the television set 100.

Furthermore, by causing the display screen of the smartphone 200 to face downward, it is possible to remove information of a confidential content from the content list. In particular, it is possible to remove information (URL) of a storage place of the confidential content. Therefore, the television set 100 becomes incapable of accessing the confidential content. As a result, it is possible to instantaneously stop displaying of a highly-confidential content on the television set 100.

Moreover, if the user causes the display screen 215 of the smartphone 200 to face downward, in other words, if the user takes an action of hiding the display screen 215, it is possible to stop transmission of a confidential content. The hiding of the display screen 215 is a human intuitive action for conceal something from view. Therefore, a usability of the smartphone 200 can be improved.

### Embodiment 2

The following describes a content distribution system according to Embodiment 2. In Embodiment 1, the television set 100 and the smartphone 200 are connected to each other according to DLNA®-compliant protocols. In contrast, in Embodiment 2, a television set and a smartphone are connected to each other via Wi-Fi Direct® according to Miracast®. In Miracast®, image displayed on the smartphone is mirrored on a screen of the television set. Hereinafter, the same reference numerals in Embodiment 1 are assigned to identical units in Embodiment 2, so that the identical units are not explained again.

The configuration of the content distribution system is as illustrated in FIG. 1. In Embodiment 2, a smartphone 200A described later is used instead of the smartphone 200 illustrated in FIG. 1, and a television set 100A described later is used instead of the television set 100.

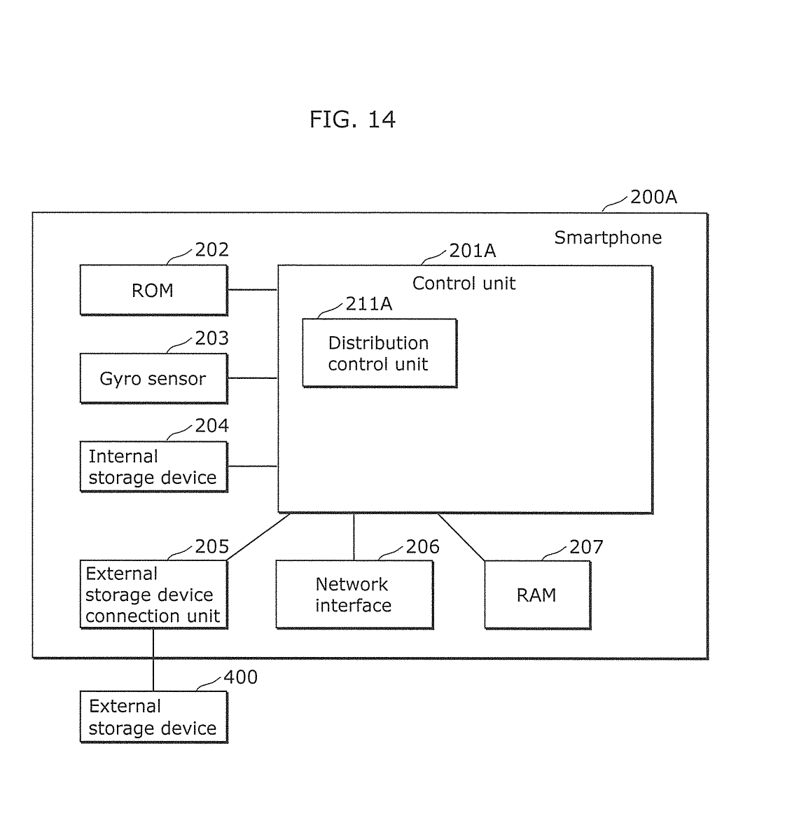

FIG. 14 is a block diagram illustrating a functional structure of the smartphone 200A.

The smartphone 200A differs from the smartphone 200 illustrated in FIG. 2 in that a control unit 201A is provided instead of the control unit 201. While the control unit 201 has the four processing units, the control unit 201A has only one processing unit (distribution control unit 211A).

Like the distribution control unit 211 according to Embodiment 1, the distribution control unit 211 controls distribution (transmission) of contents. However, the distribution control unit 211A differs from the distribution control unit 211 in that contents are transmitted via Wi-Fi Direct®.

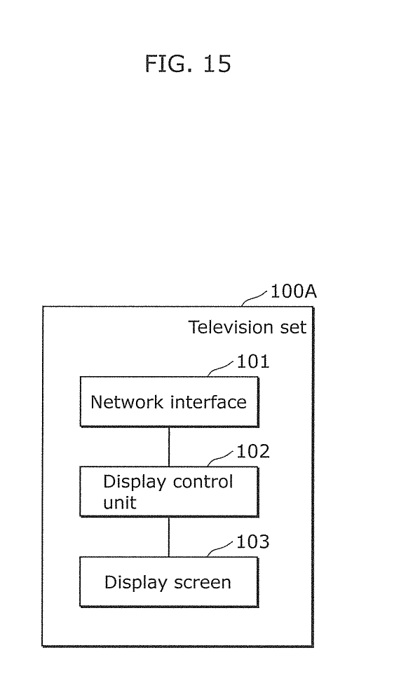

FIG. 15 is a block diagram illustrating a functional structure of the television set 100A.

The television set 100A includes a network interface 101, a display control unit 102, and a display screen 103.

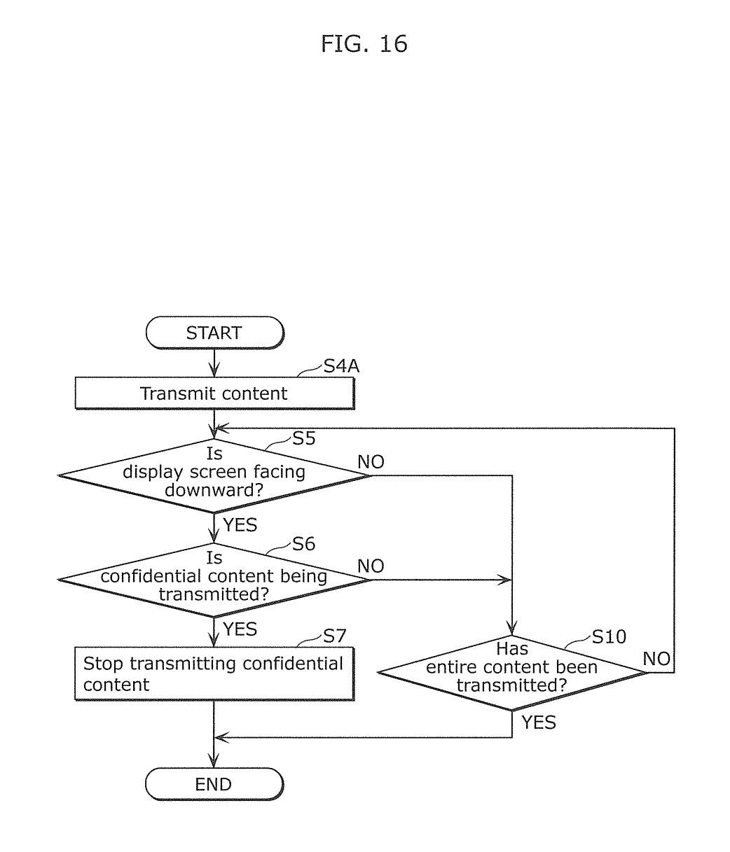

FIG. 16 is a flowchart of processing performed by the smartphone 200A.

The distribution control unit 211A transmits a content, which is currently displayed on the smartphone 200A, to the television set 100A via Wi-Fi Direct® (S4A).

After that, the processing of Steps S5 to S7 and S10 is performed. These steps are the same as described with reference to FIG. 5 according to Embodiment 1. More specifically, if the display screen of the smartphone 200A is facing downward (YES at S5) and a currently-transmitting content is confidential (YES at S6), then the distribution control unit 211A stops the transmission of the confidential content (S7). It should be noted that, since the content is being transmitted according to Miracast®, the transmission of the confidential content is stopped when the distribution control unit 211A stops displaying of the confidential content on the screen of the smartphone 200A.

The processing from S5 is performed until the entire content has been transmitted (S10).

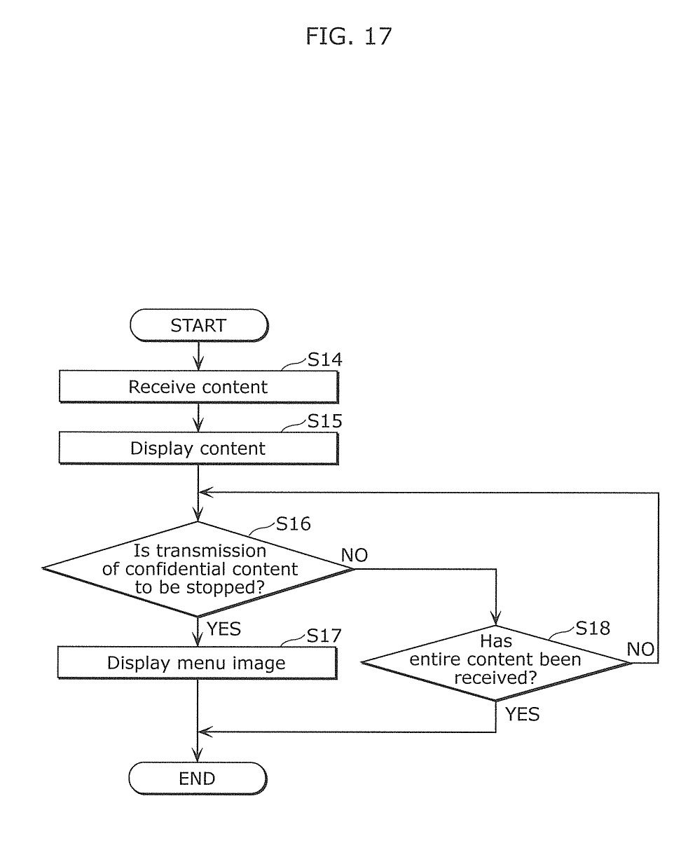

FIG. 17 is a flowchart of processing that is performed by the television set 100A according to the processing performed by the smartphone 200A in FIG. 16.

The television set 100A performs processing of Steps S14 to S18 in FIG. 9.

More specifically, the list control unit 104 receives a content transmitted from the smartphone 200A (S14), and the display control unit 102 displays the received content on the display screen 103 (S15).

If that transmission of the content that is confidential is stopped during displaying the content (YES at S16), then the display control unit 102 displays a menu image of the television set 100A instead of the confidential content (S17).

On the other hand, if the transmission of the confidential content is not stopped (NO at S16), then the processing from S16 is repeated until the entire content has been received (S18).

As described above, according to Embodiment 2, even if content transmission is performed according to Miracast®, it is possible to instantaneously stop displaying of a highly-confidential content like Embodiment 1.

### Other Embodiments

Thus, although the content distribution system has been described according to the above embodiments, the present invention is not limited to the embodiments.

For example, although it has been described in Embodiments 1 and 2 that transmission of a confidential content is stopped when the display screen of the smartphone is facing downward, the direction of the smartphone is not limited to this. For example, it is also possible that transmission of a confidential content is stopped when the smartphone is placed sideways.

It should also be noted that the standard for the content distribution (transmission) is not limited to DLNA®-compliant protocols or Miracast®. The system may adopt connection according to AirPlay®.

It should be noted that the server device that distributes contents is not limited to a smartphone. Any devices, such as a tablet terminal, which the user can instantaneously change their facing direction, may be used as the server device. Even devices which the user cannot change their facing direction may be used as the server device. In this case, it is possible to control transmission of a confidential content by changing a facing direction of a remote controller of the server device. For example, if the server device is a set top box, the user changes a facing direction of the set top box in order to cause the set top box to control distribution of a confidential content.

Furthermore, although it has been described in Embodiments 1 and 2 that the television set displays a menu image after transmission of a confidential content is stopped, any other image may be displayed as long as the image is not related to the confidential content. For example, the television set may display, on the display screen, an updated content list, namely, a content list from which information of the confidential content is removed.

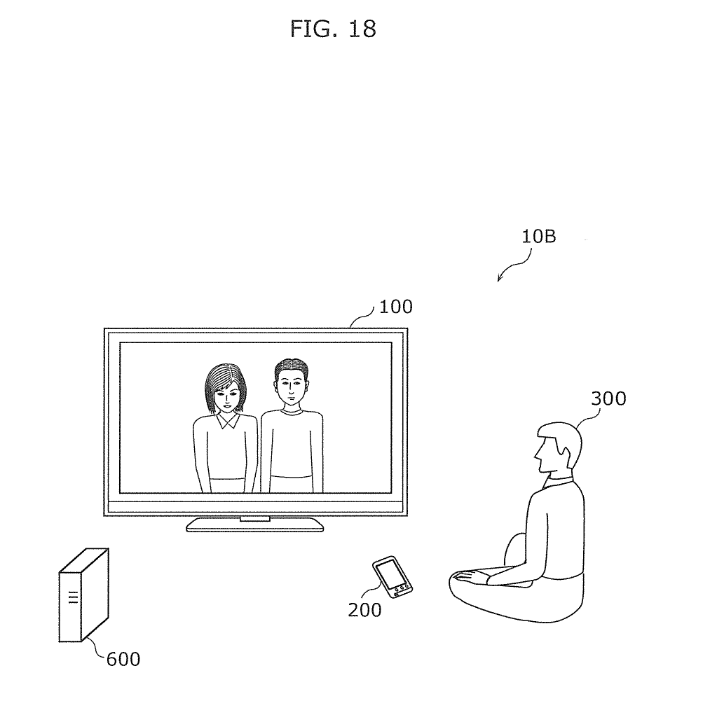

Although it has been described in Embodiment 1 that the smartphone and the television set are connected to each other based on DLNA® 2-Box model, it is also possible to connect them based on DLNA® 3-Box model. FIG. 18 is a diagram illustrating an example of a configuration of a content distribution system in DLNA® 3-Box model. A content distribution system 10B includes the television set 100, the smartphone 200, and a network access server 600. The television set 100, the smartphone 200, and the network access server 600 are connected to one another via access points. The television set 100 serves as a Digital Media Renderer (DMR). The smartphone 200 (as a content distribution control device) serves as a Digital Media Controller (DMC). The network access server 600 serves as a DMS. In other words, a content stored in the network access server 600 is transmitted to the television set 100. When the display screen of the smartphone 200 is facing downward, the smartphone 200 or the television set 100 transmits, to the network access server 600, a signal for stopping transmission of a confidential content. Then, the network access server 600 stops the transmission of the confidential content.

It should be noted that each of the above-described devices in the content distribution system may be implemented to a computer system including a microprocessor, a ROM, a RAM, a hard disk drive, a display unit, a keyboard, a mouse, and the like. The RAM or the hard disk drive holds a computer program. The microprocessor operates accruing to the computer program to cause each of the devices to perform its functions. Here, the computer program consists of combinations of instruction codes for issuing instructions to the computer to execute predetermined functions.

It should be noted that a part or all of the structural elements included in each of the above-described devices may be implemented into a single Large Scale Integration (LSI). The system LSI is a super multi-function LSI that is a single chip into which a plurality of structural elements are integrated. More specifically, the system LSI is a computer system including a microprocessor, a ROM, a RAM, and the like. The RAM holds a computer program. The microprocessor operates according to the computer program to cause the system LSI to perform its functions.

It should also be noted that a part or all of the structural elements included in each of the above-described devices may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to perform its functions. The IC card or the module may have tamper resistance.

It should also be noted that the present invention may be the above-described method. The present invention may be a computer program causing a computer to execute the method, or digital signals indicating the computer program.

It should also be noted that the present invention may be a non-transitory computer-readable recording medium on which the computer program or the digital signals are recorded. Examples of the non-transitory computer-readable recording medium are a flexible disk, a hard disk, a Compact Disc (CD)-ROM, a magnetooptic disk (MO), a Digital Versatile Disc (DVD), a DVD-ROM, a DVD-RAM, a BD (Blu-ray® Disc), and a semiconductor memory. It should be noted that the present invention may be the above-described digital signal recorded on the non-transitory computer-readable recording medium.

It should also be noted in the present invention that the computer program or the digital signals may be transmitted via an electric communication line, a wired or wireless communication line, a network represented by the Internet, data broadcasting, and the like.

It should also be noted that the present invention may be a computer system including a microprocessor operating according to the computer program and a memory storing the computer program

It should also be noted that the program or the digital signals may be recorded onto the non-transitory computer-readable recording medium to be transferred, or may be transmitted via a network or the like, so that the program or the digital signals can be executed by a different independent computer system.

It should also be noted that the above-described embodiments and their variations may be combined.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention can be applied to a content distribution system and the like in each of which a server device transmits a content to a client device and the client device displays the content.

1. A server device that transmits a content to a client device that displays the content on a screen, the server device comprising:
a direction detection unit configured to detect a direction that the server device is facing; and
a control unit configured to stop transmission of a confidential content when the direction detection unit detects that the server device is facing a predetermined direction, the confidential content being a predetermined content for which confidentiality is to be preserved.

2. The server device according to claim 1,
wherein the control unit is further configured to transmit a list to the client device when the direction detection unit detects that the server device is facing the predetermined direction, the list indicating a storage place of each of contents except the confidential content, and
the client device obtains the each of the contents from the storage place indicated in the list received from the control unit, and displays the each of the contents on the screen.

3. The server device according to claim 1,
wherein the control unit is configured to stop the transmission of the confidential content when the direction detection unit detects that a display screen of the server device is facing downward.

4. The server device according to claim 1,
wherein the control unit is further configured to maintain the stopping of the transmission of the confidential content when the direction detection unit detects that the server device is facing a direction different from the predetermined direction after facing the predetermined direction.

5. The server device according to claim 1,
wherein the server device is a digital media server in 2-Box model of Digital Living Network Alliance® (DLNA)-compliant protocols to transmit the content to the client device, and
the client device is a digital media player in the 2-Box model of the DLNA®-compliant protocols.

6. The server device according to claim 1,
wherein the server device transmits a content currently displayed on the server device, to the client device according to Miracast®, and
the control unit is configured to, when the direction detection unit detects that the server device is facing the predetermined direction, stop the transmission of the confidential content by stopping displaying of the confidential content on the server device.

7. A content distribution control device that controls transmission of a content from a server device to a client device that displays the content on a screen, the content distribution control device comprising:
a direction detection unit configured to detect a direction that the content distribution control device is facing; and
a control unit configured to stop transmission of a confidential content from the server device to the client device, when the direction detection unit detects that the content distribution control device is facing a predetermined direction, the confidential content being a predetermined content for which confidentiality is to be preserved.

8. A content distribution system comprising:
a server device that transmits a content; and
a client device that receives the content transmitted from the server device and displays the content on a screen,
wherein the server device includes:
a direction detection unit configured to direct a direction that the server device is facing; and
a control unit configured to stop transmission of a confidential content when the direction detection unit detects that the server device is facing a predetermined direction, the confidential content being a predetermined content for which confidentiality is to be preserved.

9. The content distribution system according to claim 8,
wherein the client device displays, on the screen, a predetermined image not including the confidential content, when the server device stops the transmission of the confidential content.

10. The content distribution system according to claim 9,
wherein the predetermined image is a predetermined menu image.

11. The content distribution system according to claim 9,
wherein the predetermined image is an image of a list of one or more contents except the confidential content.
